(19) United States
(12) Patent Application Publication
(10) Pub. No.: US 2026/0278852 A1
(43) Pub. Date: Sep. 17, 2026

(54) FACE ENCODER INCLUDING FACE VISION TRANSFORMER AND TEXT-CONDITIONED IMAGE ENCODER

(71) Applicant: Bytedance Technology Ltd., Grand Cayman (KY)

(72) Inventors: Zichuan Liu, Los Angeles, CA (US); Qing Yan, Los Angeles, CA (US); Xin Lu, Los Angeles, CA (US); Liming Jiang, Los Angeles, CA (US); Yumin Jia, Los Angeles, CA (US); Hao Kang, Los Angeles, CA (US); Efstathios Fotiadis, Los Angeles, CA (US); Min Jin Chong, Los Angeles, CA (US)

(21) Appl. No.: 19/090,235

(22) Filed: Mar. 25, 2025

(30) Foreign Application Priority Data
Mar. 16, 2025 (GR) 20250100186

(51) Int. Cl. G06T 11/00; G06V 10/774; G06V 10/82; G06V 40/16

(52) U.S. Cl. CPC G06T 11/00; G06V 10/774; G06V 40/172; G06V 10/82

(57) ABSTRACT

A computing system including one or more processing devices configured to receive a text prompt and receive an input image depicting a face. At a face encoder that includes a face vision transformer and a text-conditioned image encoder, the one or more processing devices compute a first face embedding at the face vision transformer based at least on the input image. The one or more processing devices compute a face token sequence at the text-conditioned image encoder based at least on a face identification text prompt and the first face embedding. At one or more text encoders, the one or more processing devices compute a text token sequence based at least on the text prompt. At a first diffusion model, the one or more processing devices compute and output an output image based at least in part on the face token sequence and the text token sequence.

### CROSS-REFERENCE TO RELATED APPLICATION(S)

This application claims priority to Greek Application No. 20250100186 filed on Mar. 16, 2025, the disclosure of which is incorporated herein by reference in its entirety.

### BACKGROUND

Text-to-image (T2I) models have greatly increased in usage in recent years as machine learning (ML) model capabilities have advanced. A T2I model receives a text input and generates a corresponding output image that reflects a description provided in the text input. Thus, a user of the T2I model uses the text input to control the contents and style of the generated output image.

Some T2I models also receive a reference image as an input in addition to the text input. When a T2I model processes the reference image, the T2I model generates an output image that includes attributes of the reference image, such as one or more stylistic features and/or depicted subjects. As in T2I generation without a reference image, a T2I model that makes use of a reference image also conditions the generation of the output image on the text input. The user may accordingly use both text and image inputs to control output image generation at the T2I model.

### SUMMARY

According to one aspect of the present disclosure, a computing system is provided, including one or more processing devices configured to receive a text prompt and receive an input image depicting a face. At a face encoder that includes a face vision transformer and a text-conditioned image encoder, the one or more processing devices are further configured to compute a first face embedding. The first face embedding is computed at the face vision transformer based at least in part on the input image. The one or more processing devices are further configured to compute a face token sequence at the text-conditioned image encoder based at least in part on a face identification text prompt and the first face embedding. At one or more text encoders, the one or more processing devices are further configured to compute a text token sequence based at least in part on the text prompt. At a first diffusion model, the one or more processing devices are further configured to compute an output image based at least in part on the face token sequence and the text token sequence. The one or more processing devices are further configured to output the output image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically depicts a computing system including one or more processing devices configured to perform image-conditioned T2I generation using a face encoder and a first diffusion model, according to one example embodiment.

FIG. 2 schematically show a first text encoder and a second text encoder that may be executed at the computing system, according to the example of FIG. 1.

FIG. 3 schematically shows the computing system during training of the face encoder, according to the example of FIG. 1.

FIG. 4A shows a flowchart of a method for use with a computing system to perform image-conditioned T2I generation, according to the example of FIG. 1.

FIG. 4B shows additional steps of the method of FIG. 4A that may be performed in examples in which the T2I generation further utilizes a control network.

FIG. 4C shows additional steps of the method of FIG. 4A that may be performed to train the face encoder.

FIG. 5 shows a schematic view of an example computing environment in which the computing system of FIG. 1 may be instantiated.

### DETAILED DESCRIPTION

In many instances in which T2I generation is performed using a reference image as an additional input, the reference image depicts the face of the user or another subject. For example, using the text input, the user may instruct a T2I model to change the facial expression or body pose of the subject shown in the reference image, to place the depicted subject into a different background, to modify an outfit worn by the depicted subject, or generate an output image that makes some other modification to the depicted subject's appearance.

The user who prompts the T2I model typically intends for the subject depicted in the output image to be recognizable as the subject depicted in the reference image. However, existing T2I models often fail to preserve recognizability of the depicted subject. Existing face-preserving T2I generation models typically use a face recognition model to extract a compact face feature from a reference image. This face feature acts as a conditioning input in a classifier-free guidance (CFG) T2I workflow. The quality of the output image is highly dependent on the face feature. However, the face recognition model is typically trained on a discriminative task, which fails to provide fine-grained details of the reference face.

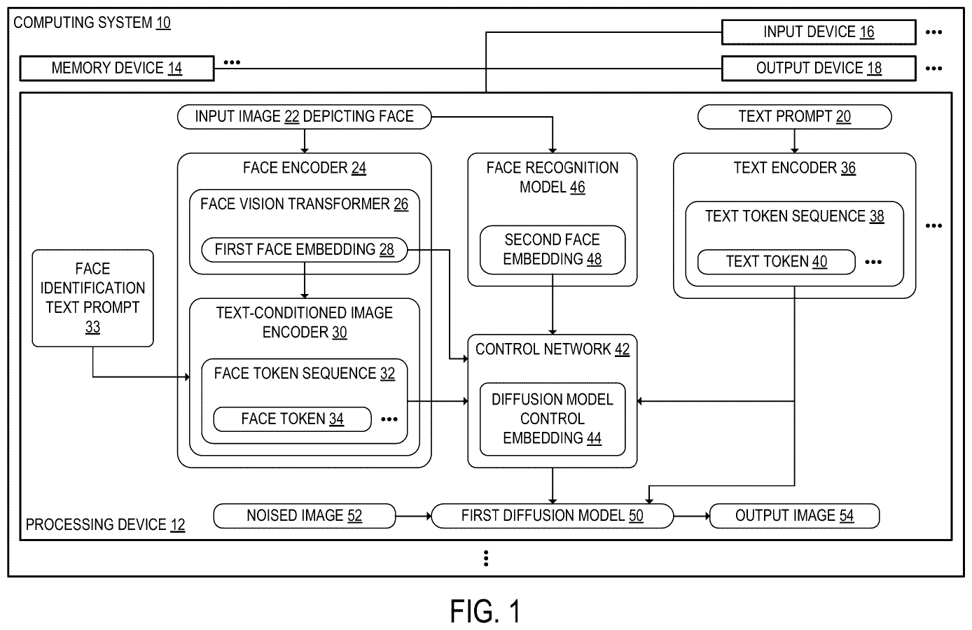

FIG. 1 schematically depicts a computing system 10 configured to address the above challenges. As discussed in further detail below, the computing system 10 is configured to execute a face encoder 24 that conditions the generation of an output image 54 at a first diffusion model 50. The computing system 10 is further configured to execute a control network 42 that guides the first diffusion model 50 using a diffusion model control embedding 44 that fuses multiple different input types, including outputs of the face encoder 24.

The computing system 10 includes one or more processing devices 12 and one or more memory devices 14. For example, the one or more processing devices 12 may include one or more central processing units (CPUs), graphics processing units (GPUs), and/or neural processing units (NPUs). The one or more memory devices 14 may include volatile memory and/or non-volatile storage. The computing system 10 further includes one or more input devices 16 and one or more output devices 18 via which a user may interact with the computing system 10. The one or more input devices and the one or more output devices 18 may be used to present a graphical user interface (GUI) at which the user may enter the inputs of T2I generation and view the output image 54.

In some examples, the computing system 10 is instantiated across a plurality of physical computing devices. For example, the computing system 10 may have a server-client configuration in which the inputs and outputs of the T2I generation pipeline are client-facing and intermediate stages of the T2I generation pipeline are offloaded to a server computing device. In the server-client configuration, the output image 54 may also be distributed for display at a plurality of different client devices.

As shown in the example of FIG. 1, the one or more processing devices 12 are configured to receive a text prompt 20. In addition, the one or more processing devices 12 are further configured to receive an input image 22 depicting a face. The text prompt 20 and the input image 22 may be received as user inputs via the one or more input devices 16.

The one or more processing devices 12 are further configured to execute a face encoder 24 that includes a face vision transformer (ViT) 26 and a text-conditioned image encoder 30. The text-conditioned image encoder 30 may, for example, be a pretrained text-conditioned image encoder. The face ViT 26 may be trained as discussed in further detail below.

The one or more processing devices 12 are configured to compute a first face embedding 28 at the face ViT 26 based at least in part on the input image 22. Accordingly, the face ViT 26 is configured to extract facial features of the face depicted in the input image 22.

The one or more processing devices 12 are further configured to compute a face token sequence 32 at the text-conditioned image encoder 30 based at least in part on a face identification text prompt 33 and the first face embedding 28. For example, the face identification text prompt 33 may be “Photo of id person.” The one or more processing devices 12 may be configured to programmatically prompt the text-conditioned image encoder 30 with the face identification text prompt 33, rather than receiving the face identification text prompt 33 as a user input in each instance in which the one or more processing devices 12 generate an output image 54. The face token sequence 32 includes a plurality of face tokens 34 that encode features of the face depicted in the input image 22.

The one or more processing devices 12 are further configured to compute a text token sequence 38 at one or more text encoders 36 based at least in part on the text prompt 20. The text token sequence 38 includes one or more text tokens 40. The one or more text encoders 36 may be pretrained text encoders.

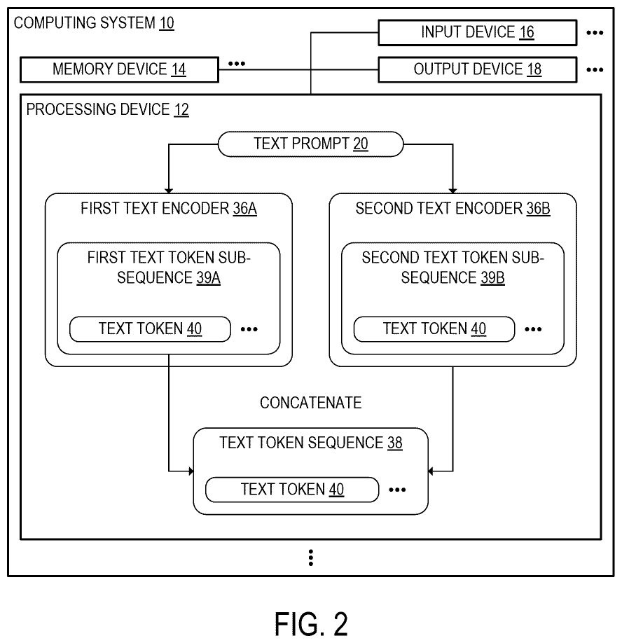

In some examples, a single text encoder 36 may be used. Alternatively, as shown in FIG. 2, the one or more text encoders 36 include a first text encoder 36A and a second text encoder 36B. In the example of FIG. 2, the one or more processing devices 12 are configured to compute a first text token sub-sequence 39A at the first text encoder 36A and a second text token sub-sequence 39B at the second text encoder 36B. The one or more processing devices 12 are further configured to concatenate the first text token sub-sequence 39A with the second text token sub-sequence 39B to compute the text token sequence 38.

Returning to the example of FIG. 1, the one or more processing devices 12 are further configured to compute an output image 54 at a first diffusion model 50 based at least in part on the face token sequence 32 and the text token sequence 38. The first diffusion model 50 may have a UNet architecture. The one or more processing devices 12 are further configured to output the output image 54. For example, the one or more processing devices 12 may be configured to output the output image 54 for display to the user at a GUI via one or more display devices included among the one or more output devices 18.

In the example of FIG. 1, the one or more processing devices 12 are further configured to execute a control network 42 configured compute a diffusion model control embedding 44 based at least in part on the face token sequence 32 and the text token sequence 38. For example, the control network 42 may have a ControlNet architecture that duplicates a UNet included in the first diffusion model 50.

The one or more processing devices 12 are further configured to compute the output image 54 at the first diffusion model 50 based at least in part on the diffusion model control embedding 44. In the example of FIG. 1, the first diffusion model 50 also receives the text token sequence 38 as an input. During computation of the output image 54, the one or more processing devices 12 are configured to iteratively denoise a noised image 52 in a denoising process conditioned on the diffusion model control embedding 44 and the text token sequence 38.

As shown in the example of FIG. 1, the control network 42 may be further configured to receive other inputs in addition to the face token sequence 32 and the text token sequence 38. For example, the one or more processing devices 12 may be configured to compute the diffusion model control embedding 44 at the control network 42 based at least in part on the first face embedding 28.

In some examples, the one or more processing devices 12 are further configured to compute a second face embedding 48 at a face recognition model 46 based at least in part on the input image 22. The face recognition model 46 may be a pretrained face recognition model. The one or more processing devices 12 may be further configured to compute the diffusion model control embedding 44 at the control network 42 based at least in part on the second face embedding 48. The face embeddings accordingly provide the control network 42 with additional facial feature data computed from the input image 22.

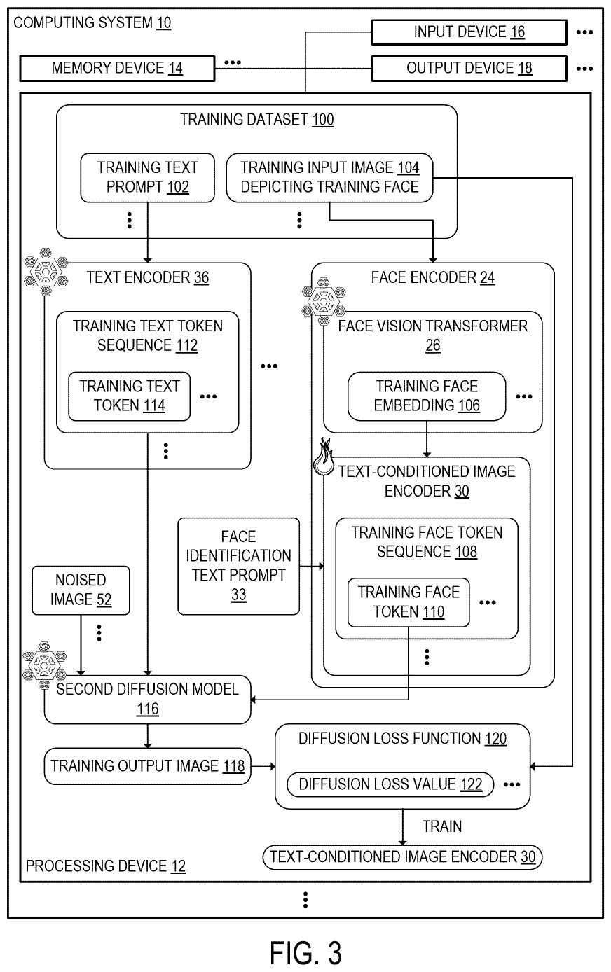

FIG. 3 schematically shows the computing system 10 during training of the face encoder 24. The one or more processing devices 12 are configured to train the face encoder 24 using a training dataset 100 that includes a plurality of training text prompts 102 and a corresponding plurality of training input images 104. The training input images 104 depict respective training faces. The training text prompts 102 and the training input images 104 form a plurality of text-image pairs.

During the training of the face encoder 24, the one or more processing devices 12 are configured to compute a plurality of training face token sequences 108 at the face encoder 24 based at least in part on the training input images 104. To compute the training face token sequences 108, the one or more processing devices 12 are configured to process the training input images 104 at the face ViT 26 to obtain a respective plurality of training face embeddings 106. The one or more processing devices 12 are further configured to process the training face embeddings 106 at the text-conditioned image encoder 30 to compute the training face token sequences 108. The text-conditioned image encoder 30 also receives the face identification text prompt 33 as an input to the generation of each of the training face token sequences 108. Each of the training face token sequences 108 includes a plurality of training face tokens 110.

The one or more processing devices 12 are further configured to compute a plurality of training text token sequences 112 at the one or more text encoders 36 based at least in part on the training text prompts 102. The training text token sequence 112 includes a plurality of training text tokens 114.

The one or more processing devices 12 are further configured to compute a plurality of training output images 118 at a second diffusion model 116 based at least in part on the training face token sequences 108 and the training text token sequences 112. When computing the training output images 118, the one or more processing devices 12 are configured to initialize the training output images 118 as respective noised images 52 and denoise the noised images 52 over a plurality of denoising iterations. The denoising iterations for each training output image 118 are conditioned on the corresponding training text token sequence 112 and the corresponding training face token sequence 108.

In some examples, the second diffusion model 116 used when training the face encoder 24 differs from the first diffusion model 50 used with the face encoder 24 at inferencing time. For example, a second diffusion model 116 with fewer parameters than the first diffusion model 50 may be used during training in order to reduce computational costs associated with training the face encoder 24. Similarly to the first diffusion model 50, the second diffusion model 116 may have a UNet architecture.

The training of the face encoder 24 is performed using a diffusion loss function 120. At the diffusion loss function 120, the one or more processing devices 12 are further configured to compute a plurality of diffusion loss values 122 between the training output images 118 and the training input images 104. The one or more processing devices 12 are further configured to train the face encoder 24 based at least in part on the diffusion loss values 122. In the example of FIG. 3, training the face encoder 24 includes performing gradient descent to modify the weights of the text-conditioned image encoder 30. In contrast, the weights of the face vision transformer 26 are frozen during the training of the face encoder 24. The weights of the second diffusion model 116 are also frozen during the training of the face encoder 24, as are the weights of the one or more text encoders 36.

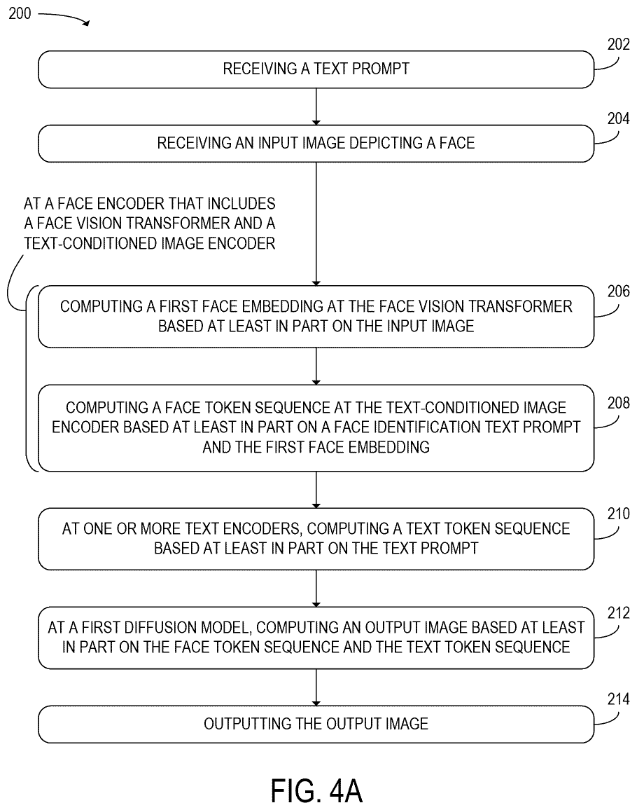

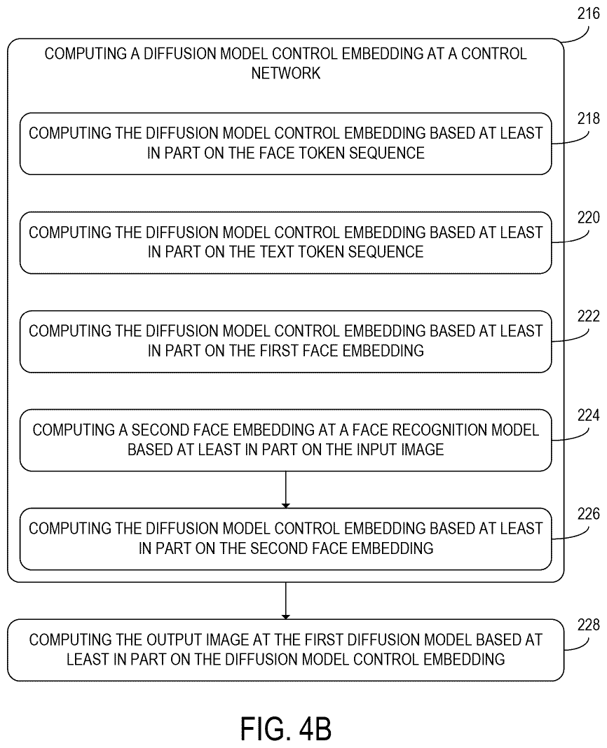

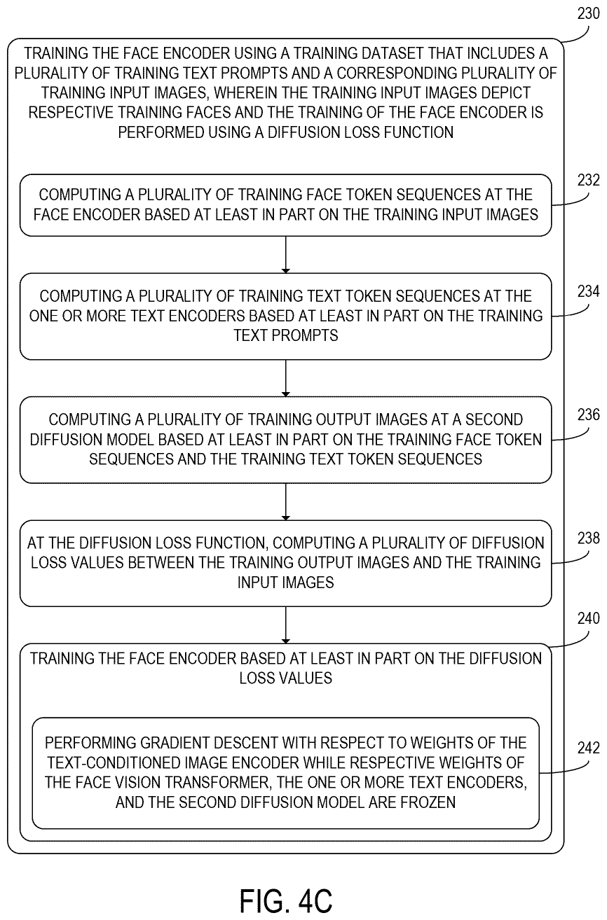

FIG. 4A shows a flowchart of a method 200 for use with a computing system to perform image-conditioned T2I generation. At step 202, the method 200 includes receiving a text prompt. At step 204, the method 200 further includes receiving an input image depicting a face. For example, the text prompt and the input image may be received as user inputs via a GUI.

Steps 206 and 208 are performed at a face encoder that includes a face ViT and a text-conditioned image encoder. At step 206, the method 200 further includes computing a first face embedding at the face ViT based at least in part on the input image. At step 208, the method 200 further includes computing a face token sequence at the text-conditioned image encoder based at least in part on a face identification text prompt and the first face embedding. The face token sequence includes a plurality of face tokens.

At step 210, the method 200 further includes computing a text token sequence at one or more text encoders based at least in part on the text prompt. The text token sequence includes a plurality of text tokens. In some examples, the text token sequence is computed at a single text encoder. In other examples, the text token sequence may include a plurality of text token sub-sequences computed at different corresponding text encoders.

At step 212, the method 200 further includes computing an output image at a first diffusion model based at least in part on the face token sequence and the text token sequence. The output image is computed over a plurality of denoising iterations, starting from a noised image. At step 214, the method 200 further includes outputting the output image. For example, the output image may be output to a GUI for display to the user.

FIG. 4B shows additional steps of the method 200 that may be performed in examples in which the T2I generation pipeline further includes a control network. At step 216, the method 200 further includes computing a diffusion model control embedding at the control network. For example, the control network may have a ControlNet architecture that duplicates a UNet included in the first diffusion model.

At step 218, step 216 may include computing the diffusion model control embedding based at least in part on the face token sequence. Additionally or alternatively, at step 220, step 216 may further include computing the diffusion model control embedding at the control network based at least in part on the text token sequence. Additionally or alternatively, at step 222, step 216 may further include computing the diffusion model control embedding at the control network based at least in part on the first face embedding.

In some examples, at step 224, step 216 may further include computing a second face embedding at a face recognition model based at least in part on the input image. In examples in which step 224 is performed, step 216 may further include, at step 226, computing the diffusion model control embedding at the control network based at least in part on the second face embedding.

At step 228, the method 200 may further include computing the output image at the first diffusion model based at least in part on the diffusion model control embedding. The diffusion model control embedding is accordingly used to guide the denoising process in a manner that combines a plurality of different input sources. By combining multiple different embeddings and/or token sequences that represent the face depicted in the input image, the control network may guide the denoising process to preserve the recognizability of the depicted face.

FIG. 4C shows additional steps of the method 200 that may be performed to train the face encoder. At step 230, the method 200 includes training the face encoder using a training dataset that includes a plurality of training text prompts and a corresponding plurality of training input images. The training input images depict respective training faces. In the example of FIG. 4C, the training of the face encoder is performed using a diffusion loss function.

At step 232, step 230 may include computing a plurality of training face token sequences at the face encoder based at least in part on the training input images. Each of the training face token sequences may include a respective plurality of training face tokens. When computing the training face token sequences, respective training face embeddings may be computed at the face ViT based at least in part on the training input images. Those training face embeddings may then be used as inputs to the text-conditioned image encoder, which computes the training face token sequences. The computation of the training face token sequences at the text-conditioned image encoder may also utilize the face identification text prompt as an additional input.

At step 234, step 230 may further include computing a plurality of training text token sequences at the one or more text encoders based at least in part on the training text prompts. The training text token sequences each include one or more training text tokens.

At step 236, step 230 may further include computing a plurality of training output images at a second diffusion model based at least in part on the training face token sequences and the training text token sequences. The training output images may each be computed over a respective plurality of diffusion iterations, starting from a noised image. In some examples, the second diffusion model executed at step 236 differs from the first diffusion model executed at step 212.

At step 238, step 230 may further include computing a plurality of diffusion loss values at the diffusion loss function. The diffusion loss values may be computed between the training output images and the training input images. At step 240, step 230 may further include training the face encoder based at least in part on the diffusion loss values. At step 242, the face encoder may be trained by performing gradient descent with respect to weights of the text-conditioned image encoder while respective weights of the face ViT, the one or more text encoders, and the second diffusion model are frozen.

Using the systems and methods discussed above, image-conditioned T2I generation is performed using a reference image that depicts a face. Compared to previous image-conditioned T2I generation techniques, the facial features shown in the reference image are more accurately preserved. This preservation of facial features may therefore result in output images that are more easily recognizable as depicting the individual shown in the reference image, compared to output images generated with previous approaches. In addition, the systems and methods discussed above achieve this increase in facial recognizability without reducing prompt adherence. The systems and methods discussed above also increase the overall image quality of the generated output images.

The methods and processes described herein are tied to a computing system of one or more computing devices. In particular, such methods and processes can be implemented as a computer-application program or service, an application-programming interface (API), a library, and/or other computer-program product.

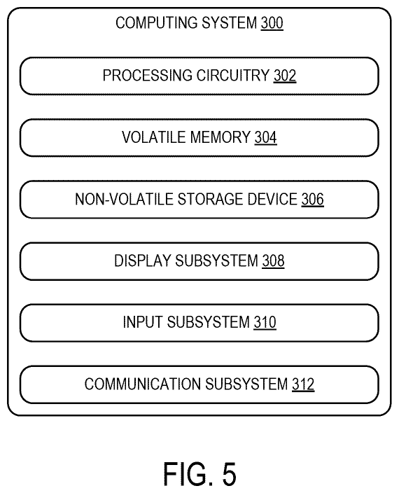

FIG. 5 schematically shows a non-limiting embodiment of a computing system 300 that can enact one or more of the methods and processes described above. Computing system 300 is shown in simplified form and may instantiate the computing system 10 depicted in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 5.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed, e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory 304, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs discuss several aspects of the present disclosure. According to one aspect of the present disclosure, a computing system is provided, including one or more processing devices configured to receive a text prompt and receive an input image depicting a face. At a face encoder that includes a face vision transformer and a text-conditioned image encoder, the one or more processing devices are further configured to compute a first face embedding at the face vision transformer based at least in part on the input image. At the face encoder, the one or more processing devices are further configured to compute a face token sequence at the text-conditioned image encoder based at least in part on a face identification text prompt and the first face embedding. At one or more text encoders, the one or more processing devices are further configured to compute a text token sequence based at least in part on the text prompt. At a first diffusion model, the one or more processing devices are further configured to compute an output image based at least in part on the face token sequence and the text token sequence. The one or more processing devices are further configured to output the output image. The above features may have the technical effect of preserving detailed features of the face depicted in the input image while also maintaining prompt adherence.

According to this aspect, the one or more processing devices may be further configured to compute a diffusion model control embedding at a control network based at least in part on the face token sequence. The one or more processing devices may be further configured to compute the output image at the first diffusion model based at least in part on the diffusion model control embedding. The above features may have the technical effect of combining multiple different input types into a diffusion model control embedding that is used to guide the T2I generation performed at the first diffusion model.

According to this aspect, the one or more processing devices may be further configured to compute a second face embedding at a face recognition model based at least in part on the input image. At the control network, the one or more processing devices may be further configured to compute the diffusion model control embedding based at least in part on the second face embedding. The above features may have the technical effect of incorporating the output of a face recognition model into the computation of the diffusion model control embedding in order to indicate the location of the face in the input image.

According to this aspect, the one or more processing devices may be configured to compute the diffusion model control embedding at the control network based at least in part on the text token sequence. The above features may have the technical effect of incorporating the text token sequence into the computation of the diffusion model control embedding in order to increase prompt adherence.

According to this aspect, the one or more processing devices may be configured to compute the diffusion model control embedding at the control network based at least in part on the first face embedding. The above features may have the technical effect of incorporating the first face embedding computed at the face vision transformer into the computation of the diffusion model control embedding in order to more accurately preserve facial features depicted in the input image.

According to this aspect, the one or more text encoders may include a first text encoder and a second text encoder. The one or more processing devices may be configured to compute the text token sequence at least in part by concatenating a first text token sub-sequence computed at the first text encoder with a second text token sub-sequence computed at the second text encoder. The above features may have the technical effect of increasing prompt adherence by utilizing first and second text token sub-sequences computed at different text encoders.

According to this aspect, the one or more processing devices may be further configured to train the face encoder using a training dataset that includes a plurality of training text prompts and a corresponding plurality of training input images. The training input images may depict respective training faces. The training of the face encoder may be performed using a diffusion loss function. The above features may have the technical effect of training the face encoder.

According to this aspect, during the training of the face encoder, the one or more processing devices may be configured to compute a plurality of training face token sequences at the face encoder based at least in part on the training input images. The one or more processing devices may be further configured to compute a plurality of training text token sequences at the one or more text encoders based at least in part on the training text prompts. The one or more processing devices may be further configured to compute a plurality of training output images at a second diffusion model based at least in part on the training face token sequences and the training text token sequences. At the diffusion loss function, the one or more processing devices may be further configured to compute a plurality of diffusion loss values between the training output images and the training input images. The one or more processing devices may be further configured to train the face encoder based at least in part on the diffusion loss values. The above features may have the technical effect of training the face encoder such that the face encoder accurately guides the second diffusion model to reproduce the training input images.

According to this aspect, weights of the second diffusion model may be frozen during the training of the face encoder. The above feature may have the technical effect of preserving the image generation capabilities of the second diffusion model during training of the face encoder.

According to this aspect, weights of the face vision transformer may be frozen during the training of the face encoder. The above feature may have the technical effect of preserving the ability of the face vision transformer to compute face embeddings during the training of the face encoder.

According to another aspect of the present disclosure, a method for use with a computing system is provided. The method includes receiving a text prompt and receiving an input image depicting a face. At a face encoder that includes a face vision transformer and a text-conditioned image encoder, the method may further include computing a first face embedding at the face vision transformer based at least in part on the input image. The method may further include computing a face token sequence at the text-conditioned image encoder based at least in part on a face identification text prompt and the first face embedding. At one or more text encoders, the method may further include computing a text token sequence based at least in part on the text prompt. At a first diffusion model, the method may further include computing an output image based at least in part on the face token sequence and the text token sequence. The method may further include outputting the output image. The above features may have the technical effect of preserving detailed features of the face depicted in the input image while also maintaining prompt adherence.

According to this aspect, at a control network, the method may further include computing a diffusion model control embedding based at least in part on the face token sequence. The method may further include computing the output image at the first diffusion model based at least in part on the diffusion model control embedding. The above features may have the technical effect of combining multiple different input types into a diffusion model control embedding that is used to guide the T2I generation performed at the first diffusion model.

According to this aspect, the method may further include computing a second face embedding at a face recognition model based at least in part on the input image. At the control network, the method may further include computing the diffusion model control embedding based at least in part on the second face embedding. The above features may have the technical effect of incorporating the output of a face recognition model into the computation of the diffusion model control embedding in order to indicate the location of the face in the input image.

According to this aspect, the method may further include computing the diffusion model control embedding at the control network based at least in part on the text token sequence. The above features may have the technical effect of incorporating the text token sequence into the computation of the diffusion model control embedding in order to increase prompt adherence.

According to this aspect, the method may further include computing the diffusion model control embedding at the control network based at least in part on the first face embedding. The above features may have the technical effect of incorporating the first face embedding computed at the face vision transformer into the computation of the diffusion model control embedding in order to more accurately preserve facial features depicted in the input image.

According to this aspect, the method may further include training the face encoder using a training dataset that includes a plurality of training text prompts and a corresponding plurality of training input images. The training input images may depict respective training faces. The training of the face encoder may be performed using a diffusion loss function. The above features may have the technical effect of training the face encoder.

According to this aspect, during the training of the face encoder, the method may further include computing a plurality of training face token sequences at the face encoder based at least in part on the training input images. The method may further include computing a plurality of training text token sequences at the one or more text encoders based at least in part on the training text prompts. The method may further include computing a plurality of training output images at a second diffusion model based at least in part on the training face token sequences and the training text token sequences. At the diffusion loss function, the method may further include computing a plurality of diffusion loss values between the training output images and the training input images. The method may further include training the face encoder based at least in part on the diffusion loss values. The above features may have the technical effect of training the face encoder such that the face encoder accurately guides the second diffusion model to reproduce the training input images.

According to this aspect, weights of the second diffusion model may be frozen during the training of the face encoder. The above feature may have the technical effect of preserving the image generation capabilities of the second diffusion model during training of the face encoder.

According to this aspect, weights of the face vision transformer may be frozen during the training of the face encoder. The above feature may have the technical effect of preserving the ability of the face vision transformer to compute face embeddings during the training of the face encoder.

According to another aspect of the present disclosure, a computing system is provided, including one or more processing devices configured to receive a text prompt and receive an input image depicting a face. At a face encoder that includes a face vision transformer and a text-conditioned image encoder, the one or more processing devices are further configured to compute a first face embedding at the face vision transformer based at least in part on the input image. The one or more processing devices are further configured to compute a face token sequence at the text-conditioned image encoder based at least in part on a face identification text prompt and the first face embedding. At one or more text encoders, the one or more processing devices are further configured to compute a text token sequence based at least in part on the text prompt. The one or more processing devices are further configured to compute a second face embedding at a face recognition model. At a control network, the one or more processing devices are further configured to compute a diffusion model control embedding based at least in part on the face token sequence, the text token sequence, the first face embedding, and the second face embedding. At a first diffusion model, the one or more processing devices are further configured to compute an output image based at least in part on the diffusion model control embedding and the text token sequence. The one or more processing devices are further configured to output the output image. The above features may have the technical effect of preserving detailed features of the face depicted in the input image while also maintaining prompt adherence.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive a text prompt;
receive an input image depicting a face;
at a face encoder that includes a face vision transformer and a text-conditioned image encoder:
compute a first face embedding at the face vision transformer based at least in part on the input image; and
compute a face token sequence at the text-conditioned image encoder based at least in part on a face identification text prompt and the first face embedding;
at one or more text encoders, compute a text token sequence based at least in part on the text prompt;
at a first diffusion model, compute an output image based at least in part on the face token sequence and the text token sequence; and
output the output image.

2. The computing system of claim 1, wherein the one or more processing devices are further configured to:
at a control network, compute a diffusion model control embedding based at least in part on the face token sequence; and
compute the output image at the first diffusion model based at least in part on the diffusion model control embedding.

3. The computing system of claim 2, wherein the one or more processing devices are further configured to:
compute a second face embedding at a face recognition model based at least in part on the input image; and
at the control network, compute the diffusion model control embedding based at least in part on the second face embedding.

4. The computing system of claim 2, wherein the one or more processing devices are configured to compute the diffusion model control embedding at the control network based at least in part on the text token sequence.

5. The computing system of claim 2, wherein the one or more processing devices are configured to compute the diffusion model control embedding at the control network based at least in part on the first face embedding.

6. The computing system of claim 1, wherein:
the one or more text encoders include a first text encoder and a second text encoder; and
the one or more processing devices are configured to compute the text token sequence at least in part by concatenating a first text token sub-sequence computed at the first text encoder with a second text token sub-sequence computed at the second text encoder.

7. The computing system of claim 1, wherein:
the one or more processing devices are further configured to train the face encoder using a training dataset that includes a plurality of training text prompts and a corresponding plurality of training input images;
the training input images depict respective training faces; and
the training of the face encoder is performed using a diffusion loss function.

8. The computing system of claim 7, wherein, during the training of the face encoder, the one or more processing devices are configured to:
compute a plurality of training face token sequences at the face encoder based at least in part on the training input images;
compute a plurality of training text token sequences at the one or more text encoders based at least in part on the training text prompts;
compute a plurality of training output images at a second diffusion model based at least in part on the training face token sequences and the training text token sequences;
at the diffusion loss function, compute a plurality of diffusion loss values between the training output images and the training input images; and
train the face encoder based at least in part on the diffusion loss values.

9. The computing system of claim 8, wherein weights of the second diffusion model are frozen during the training of the face encoder.

10. The computing system of claim 7, wherein weights of the face vision transformer are frozen during the training of the face encoder.

11. A method for use with a computing system, the method comprising:
receiving a text prompt;
receiving an input image depicting a face;
at a face encoder that includes a face vision transformer and a text-conditioned image encoder:
computing a first face embedding at the face vision transformer based at least in part on the input image; and
computing a face token sequence at the text-conditioned image encoder based at least in part on a face identification text prompt and the first face embedding;
at one or more text encoders, computing a text token sequence based at least in part on the text prompt;
at a first diffusion model, computing an output image based at least in part on the face token sequence and the text token sequence; and
outputting the output image.

12. The method of claim 11, further comprising:
at a control network, computing a diffusion model control embedding based at least in part on the face token sequence; and
computing the output image at the first diffusion model based at least in part on the diffusion model control embedding.

13. The method of claim 12, further comprising:
computing a second face embedding at a face recognition model based at least in part on the input image; and
at the control network, computing the diffusion model control embedding based at least in part on the second face embedding.

14. The method of claim 12, further comprising computing the diffusion model control embedding at the control network based at least in part on the text token sequence.

15. The method of claim 12, further comprising computing the diffusion model control embedding at the control network based at least in part on the first face embedding.

16. The method of claim 11, further comprising training the face encoder using a training dataset that includes a plurality of training text prompts and a corresponding plurality of training input images, wherein:
the training input images depict respective training faces; and
the training of the face encoder is performed using a diffusion loss function.

17. The method of claim 16, further comprising, during the training of the face encoder:
computing a plurality of training face token sequences at the face encoder based at least in part on the training input images;
computing a plurality of training text token sequences at the one or more text encoders based at least in part on the training text prompts;
computing a plurality of training output images at a second diffusion model based at least in part on the training face token sequences and the training text token sequences;
at the diffusion loss function, computing a plurality of diffusion loss values between the training output images and the training input images; and
training the face encoder based at least in part on the diffusion loss values.

18. The method of claim 17, wherein weights of the second diffusion model are frozen during the training of the face encoder.

19. The method of claim 16, wherein weights of the face vision transformer are frozen during the training of the face encoder.

20. A computing system comprising:
one or more processing devices configured to:
receive a text prompt;
receive an input image depicting a face;
at a face encoder that includes a face vision transformer and a text-conditioned image encoder:
compute a first face embedding at the face vision transformer based at least in part on the input image; and
compute a face token sequence at the text-conditioned image encoder based at least in part on a face identification text prompt and the first face embedding;
at one or more text encoders, compute a text token sequence based at least in part on the text prompt;
compute a second face embedding at a face recognition model;
at a control network, compute a diffusion model control embedding based at least in part on the face token sequence, the text token sequence, the first face embedding, and the second face embedding;
at a first diffusion model, compute an output image based at least in part on the diffusion model control embedding and the text token sequence; and
output the output image.
